(19) United States
(12) Patent Application Publication
(10) Pub. No.: US 2026/0291905 A1
(43) Pub. Date: Sep. 24, 2026

(54) METHOD AND DEVICE FOR AUTOMATICALLY ANALYZING EMAILS

(71) Applicant: Wistron Corp., New Taipei City (TW)

(72) Inventors: Ming Chieh CHANG, New Taipei City (TW); Shinjie HU, New Taipei City (TW)

(21) Appl. No.: 19/238,767

(22) Filed: Jun. 16, 2025

(30) Foreign Application Priority Data
Mar. 20, 2025 (TW) 114110500

(51) Int. Cl. H04L 51/21; G06Q 30/0601

(52) U.S. Cl. CPC H04L 51/21; G06Q 30/0601

(57) ABSTRACT

A method for automatically analyzing emails is provided. The method is implemented by a processor of a device and includes receiving a reply email sent by a supplier device, wherein the reply email is used to reply to demands for purchasing goods. The method includes generating a report corresponding to the demands for purchasing goods using one or more large language models (LLMs) according to a subject, an email content, and replier information of the reply email.

### CROSS REFERENCE TO RELATED APPLICATIONS

This Application claims priority of Taiwan Patent Application No. 114110500, filed on March 20, 2025, the entirety of which is incorporated by reference herein.

### TECHNICAL FIELD

The present disclosure generally relates to a method and a device for automatically analyzing emails. More specifically, aspects of the present disclosure relate to a method and a device for automatically analyzing emails using an artificial intelligence model.

### BACKGROUND

Supply chain management is one of the core elements of business operations, and procurement is the key link to ensure smooth supply chain operations. An effective procurement process can not only ensure the timely supply of materials and products, but it can also help companies reduce costs and improve competitiveness. With the development of global markets, the supply chain is becoming more and more complex, and companies are increasingly in need of timely understanding of order status, delivery confirmation, changes and responses. Therefore, how to effectively manage supplier relationships and strengthen communication with manufacturers is crucial to corporate operational efficiency and market competitiveness.

However, at present, most buyers' procurement personnel still rely on traditional emails or phone calls to communicate with suppliers' manufacturers. Many suppliers are unwilling to connect with the buyer's system and will not actively use the procurement system provided by the buyer, which leads to frequent reliance on manual operations for cross-manufacturer communication. This approach is not only time-consuming, but it is also prone to problems such as communication omissions and data organization errors. Especially when it comes to a large number of orders, delivery date changes or specific demand confirmations, the traditional manual processing methods are often unable to respond in a timely and accurate manner, further affecting the efficiency and stability of the supply chain.

Therefore, there is a need for a method and device for automatically analyzing emails, so as to significantly reduce manpower input, improve work efficiency, and reduce the risk of errors. On the one hand, the method and device for automatically analyzing emails may achieve the goal of providing a faster and more accurate procurement process.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and device automatically analyzing emails. When the purchase device receives a reply email from the supplier device, the purchasing device uses a large language model to automatically analyze the content of the reply email and related information in the attachments, perform intelligent analysis on key information such as delivery confirmation and order status for each component number, and generate corresponding reports. These reports may be directly presented in the sign-off form of the device that the purchasing personnel is responsible for. The purchasing personnel only needs to review the reports and no longer needs to manually sort out a large number of reply emails. During this process, all reply emails sent by the supplier device may be automatically stored in the device for users or purchasing personnel to check at any time. The device may automatically check whether the supplier device fails to reply to the reply email within a predetermined time. When the supplier device fails to reply to the reply email within the predetermined time, the device immediately reminds the purchasing personnel to carry out follow-up processing. Therefore, the method and device for automatically analyzing emails proposed in the present disclosure can significantly reduce manual intervention and improve the efficiency of overall communication and process processing, thereby improving the accuracy and speed of the overall procurement process.

In an exemplary embodiment, a method for automatically analyzing emails is provided. The method is implemented by a processor of a device and comprises receiving a reply email sent by a supplier device, wherein the reply email is used to reply to demands for purchasing goods. The method includes generating a report corresponding to the demands for purchasing goods using one or more large language models (LLMs) according to a subject, an email content, and replier information of the reply email.

In some embodiments, the method further comprises classifying the reply email according to the email content, wherein types used to classify the reply email at least include an order inquiry, a delivery inquiry, and an order cancellation inquiry.

In some embodiments, before receiving the reply email sent by the supplier device, the method further comprises sending an inquiry email to the supplier device, wherein the inquiry email includes the demands for purchasing goods.

In some embodiments, the method further comprises comparing the inquiry email with the reply email to confirm whether the demands for purchasing goods have been responded to in the reply email and generating the report when the demands for purchasing goods have been responded to in the reply email.

In some embodiments, the method further comprises sending a notification message to notify a user using the device when the demands for purchasing goods are not responded to in the reply email.

In some embodiments, the report at least includes a material number, a delivery date, and response information of the supplier device.

In some embodiments, the reply email further includes an attachment regarding the demands for purchasing goods.

In some embodiments, the step of generating the report using the one or more LLMs further comprises reading the subject, the email content, the replier information and title information in the attachment using the one or more LLMs to generate the report.

In some embodiments, the step of generating the report using the one or more LLMs further comprises executing a program to read the subject, the email content, the replier information and title information in the attachment; executing the program to put a prompt into a template of the reply email, and providing the subject, the email content, the replier information and the attachment to the one or more LLMs, so that the one or more LLMs generate a reply result; and executing the program to generate the report based on the reply result and the reply email.

In some embodiments, the method further comprises sending an overdue notification message to a user using the device to notify the user that the device has not received the reply email sent by the supplier device when the reply email sent by the supplier device is not received within a predetermined time.

In an exemplary embodiment, a device for automatically analyzing emails is provided. The device comprises one or more processors and one or more computer storage media for storing one or more computer-readable instructions. The processor is configured to drive the computer storage media to execute the following tasks. The following tasks comprise receiving a reply email sent by a supplier device, wherein the reply email is used to reply to demands for purchasing goods. The following tasks comprise generating a report corresponding to the demands for purchasing goods using one or more large language models (LLMs) according to a subject, an email content, and replier information of the reply email.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of a system for automatically analyzing emails according to an embodiment of the present disclosure.

FIG. 2 is a flow chart showing a method for automatically analyzing emails according to an embodiment of the present disclosure.

FIG. 3A is a schematic diagram showing a reply email sent by the supplier device according to an embodiment of the present disclosure.

FIG. 3B is a schematic diagram showing the attachment in the reply email according to an embodiment of the present disclosure

FIG. 4 shows a report generated by a large language model or a program according to an embodiment of the present disclosure.

FIG. 5 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

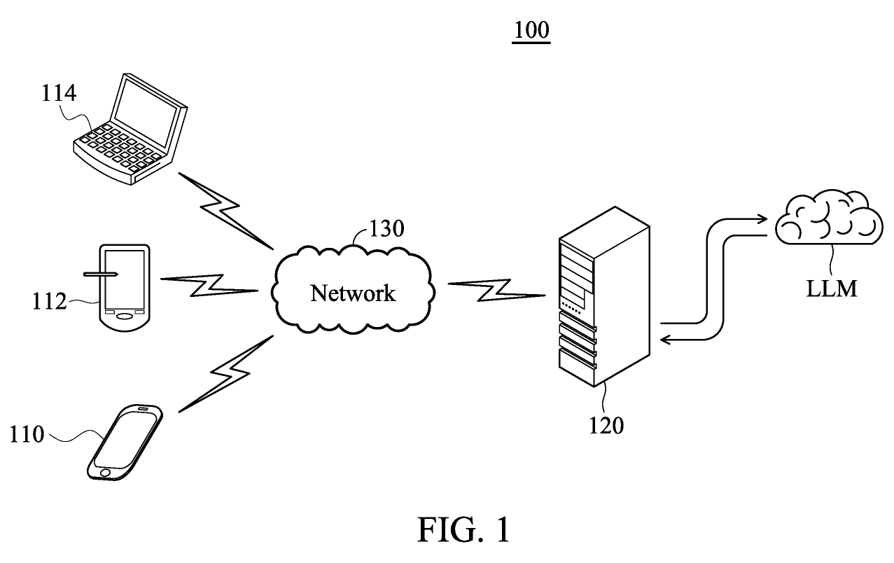

FIG. 1 is a schematic diagram of a system 100 for automatically analyzing emails according to an embodiment of the present disclosure.

As shown in FIG. 1, the system 100 may include terminal devices 110, 112, 114 belonging to a purchaser and a server 120 for executing one or more large language models (LLMs). The network 130 is used to provide a medium for communication links between the terminal devices 110, 112, 114 and the server 120. The network 130 may include various connection types, such as wired or wireless communication links or fiber optic cables, etc.

Users may use the terminal devices 110, 112 and 114 to communicate with the server 120 via the network 130 to receive or send messages, etc. Various applications for enabling information communication between the terminal devices 110, 112, 114 and the server 120 may be installed, such as email applications, model training applications, etc.

The terminal devices 110, 112, 114 and the server 120 may be hardware or software. When the terminal devices 110, 112, and 114 are hardware, they may be various electronic devices with display screens, including but not limited to smart phones, tablet computers, laptop computers, portable notebook computers, and desktop computers. When the terminal devices 110, 112 and 114 are software, they may be installed in the electronic devices listed above. The terminal devices 110, 112 and 114 may be implemented as multiple software or software modules, or may be implemented as a single software or software module, which is not specifically limited in the present disclosure. When the server 120 is hardware, it may be implemented as a distributed server cluster consisting of multiple servers, or it may be implemented as a single server. When the server is software, it may be implemented as multiple software or software modules, or as a single software or software module, which is not specifically limited in the present disclosure.

The server 120 may provide various services through various built-in applications. Taking an email application that may provide email services to users as an example, the server 120 may achieve the following effects when running the email application: the server 120 may record an inquiry email sent by the user through the terminal devices 110, 112 and 114 to a supplier device to inquire about the demands for purchasing goods, and receive a reply email sent by the supplier device to reply to the demands for purchasing goods. Next, the server 120 may use the reply email as input data to one or more pre-trained large language models (LLMs). The server 120 obtains a report corresponding to the demands for purchasing goods generated by the LLMs, wherein the report is generated based on a generation instruction input by the user through the terminal devices 110, 112 and 114. The server 120 may further transmit the report back to the terminal devices 110, 112 and 114 via the network 130, so that the terminal devices 110, 112 and 114 may present the report to the user via a display screen of the terminal devices 110, 112 and 114.

It should be noted that since training a large language model requires more computing resources and stronger computing power, the method for automatically analyzing emails provided in the various embodiments described later in this disclosure is generally executed by the server 120 with stronger computing power and more computing resources. Accordingly, the large language model may also be generally installed in the server 120. However, it should also be pointed out that when the terminal devices 110, 112, and 114 also have computing power and computing resources that meet the requirements, the terminal devices 110, 112, and 114 may also complete the various calculations performed by the server 120 in the present disclosure through the model training applications installed thereon, and then output the same results as the server 120. In other words, the large language model may also be installed in the terminal devices 110, 112 and 114. In this case, the exemplary system 100 may also not include the server 120 and the network 130.

The server 120 does not need to train a large language model by itself, but may directly call one or more trained large language models.

In addition, the number of terminal devices, networks and servers in FIG. 1 is merely illustrative. Depending on the implementation requirements, there can be any number of terminal devices, networks, and servers.

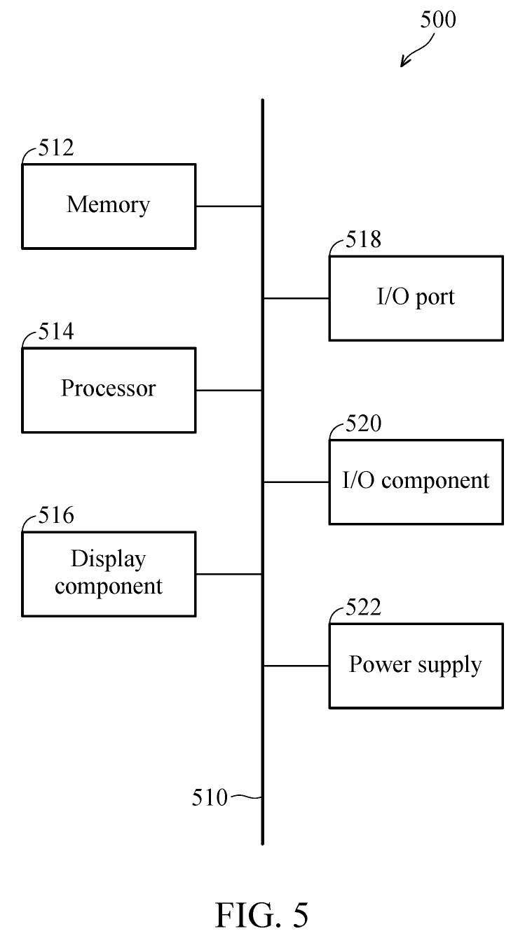

It should be understood that the terminal devices 110, 112 and 114 and the server 120 shown in FIG. 1 are examples of one suitable system 100 architecture automatically analyzing emails. Each of the devices shown in FIG. 1 may be implemented via any type of electronic device, such as the electronic device 500 described with reference to FIG. 5, for example.

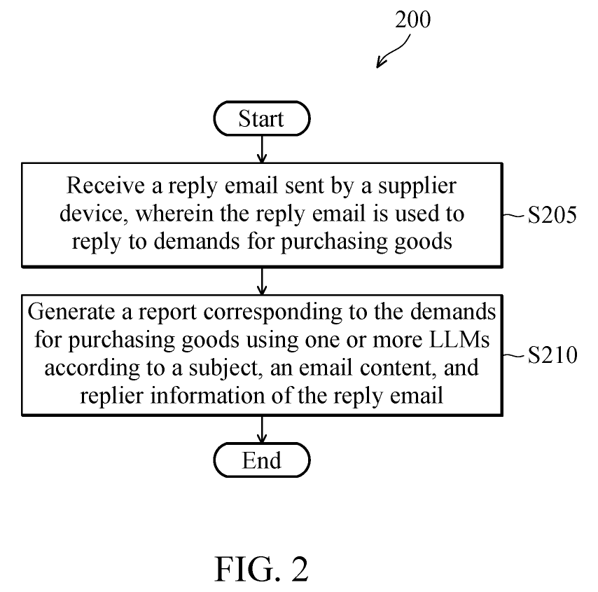

FIG. 2 is a flow chart showing a method 200 for automatically analyzing emails according to an embodiment of the present disclosure. The method may be implemented by a processor in a device, wherein the device may be the server 120 or the terminal devices 110, 112 and 114 of the system 100 shown in FIG. 1.

Before the process starts, the user sends an inquiry email to a supplier device, wherein the inquiry email includes demands for purchasing goods. In one embodiment, the inquiry email may also be sent by the server.

In step S205, the device receives a reply email sent by a supplier device to reply to the demands for purchasing goods. In one embodiment, the reply email further includes an attachment regarding the demands for purchasing goods.

In step S210, the device generates a report corresponding to the demands for purchasing goods using one or more large language models (LLMs) according to a subject, an email content, and replier information of the reply email, wherein the report at least includes the material number, the delivery date, and response information of the supplier device. In yet another embodiment, the report may further include a component number.

Specifically, the device reads the subject, the email content, the replier information and title information in the attachment using the one or more LLMs in step S210 to generate the report. In yet another embodiment, the one or more LLMs may compare the inquiry email with the reply email to confirm which original inquiry email the reply email corresponds to and whether all the demands for purchasing goods have been responded to in the reply email. In some embodiments, the comparison focuses on key information such as order status, delivery date changes, quantity, etc., to ensure that the reply email from the supplier device is consistent with the demands for purchasing goods originally mentioned in the inquiry email sent by the purchaser device. When the demands for purchasing goods are not responded to in the reply email, the device may mark the reply email and the demands for purchasing goods as inconsistent and send a notification message to notify the user using the device or the relevant purchasing personnel to carry out follow-up processing. When the demands for purchasing goods have been responded to in the reply email, the one or more LLMs generate the report.

In another embodiment, the one or more large language models classify the reply email according to the email content, wherein the types used to classify the reply email at least include an order inquiry, a delivery inquiry, and an order cancellation inquiry. In yet another embodiment, the types of the reply email may further include an OPOR inquiry and other types. These classifications help the device to handle different types of reply emails more specifically and group them into corresponding report templates to avoid confusion in the reply emails. In some embodiments, when sending inquiry emails to the supplier device, the large language model may also classify the inquiry emails, so as to subsequently compare the types of inquiry email of the corresponding reply emails to increase the accuracy of the reply emails.

To enable the large language model to accurately understand the intention of the reply email sent by the supplier device, the large language model may be assisted by using corresponding dictionaries of synonyms and different expressions that have the same meaning. Specifically, the large language model may parse the same meaning implied in different expressions and confirm whether the user using the supplier device agrees to the delivery date, accepts the order, or rejects the change. For example, a user using the supplier device may express the same intent in different ways, such as "confirm and agree to the delivery date" or "agree to the listed date", and the large language model may automatically parse and annotate the meaning of the email content. In yet another embodiment, the different expressions described above may be listed together in the report for users to view.

In another embodiment, when the reply email sent by the supplier device is not received within a predetermined time, the device may send an overdue notification message to a user using the device to notify the user that the device has not received the reply email sent by the supplier device. After receiving the overdue notification message, the user may perform corresponding follow-up processing.

In another embodiment, the device may automatically collect statistics on users' evaluation of the report generated by the large language model at regular intervals or at a fixed period. For example, whether the user accepts generation results of the report or whether the user modifies the report. For reports that are modified more frequently by users, the device may continue to optimize the large language models based on the collected data to improve the accuracy of future analysis of the large language models and ensure that the large language models may more accurately analyze the intent of the reply email sent by the supplier device.

The following may take an example to illustrate the reply email sent by the supplier device and how to generate the report in step S210.

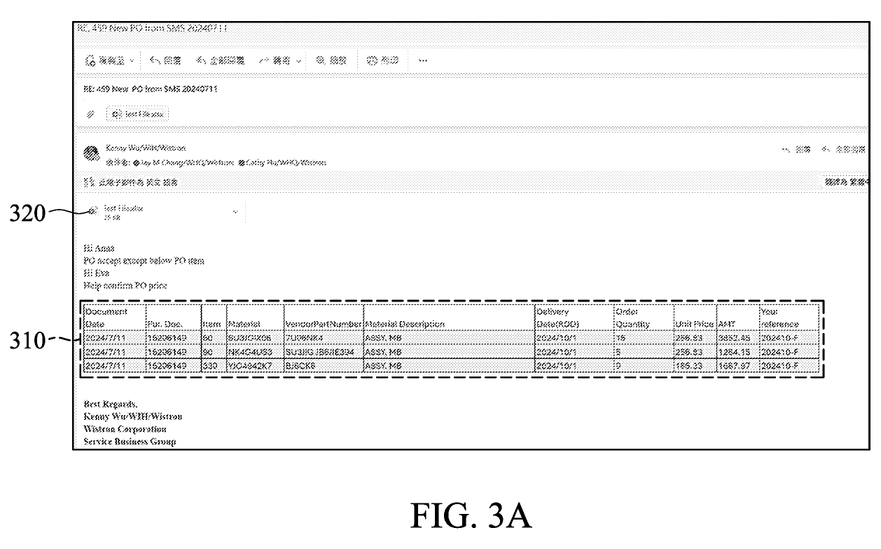

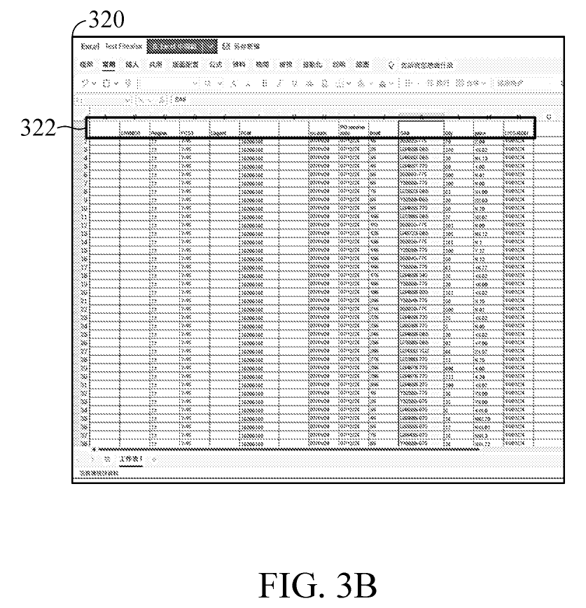

FIG. 3A is a schematic diagram showing a reply email sent by the supplier device according to an embodiment of the present disclosure. As shown in FIG. 3A, the reply email sent by the supplier device may contain a form 310 and an attachment 320.

The device may first execute a program to read the subject, the email content and the attachment 320 of the reply email. FIG. 3B is a schematic diagram showing the attachment 320 in the reply email according to an embodiment of the present disclosure. The device may execute the program to extract the row of the subject 322 in the attachment 320 and put a prompt into a template of the reply email format so that the device may reply to the reply email in a specific way. The program may then provide the subject, the email content and information included in the attachment 320 of the reply email to the large language model, so that the large language model may understand the semantics of the reply email and generate a report based on the content of the reply email. In another embodiment, after the large language model understands the semantics of the reply email and generates a reply result, the device may also execute the program to read the reply result analyzed by the large language model and generate a report in combination with the content of the original attachment 320, wherein the reply result contains the reply to the email content and the index corresponding the field in the attachment 320. It should be noted that the reply email in FIG. 3A and the attachment in FIG. 3B are not intended to limit the present disclosure, and those skilled in the art can make appropriate replacements or adjustments according to this embodiment.

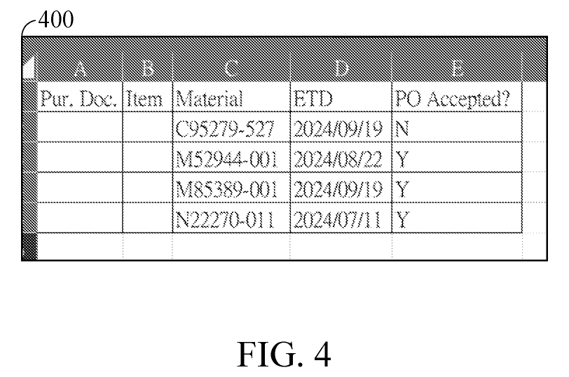

FIG. 4 shows a report 400 generated by a large language model or a program according to an embodiment of the present disclosure. As shown in FIG. 4, the large language model or the program may generate a report in combination with the content of the original inquiry email content based on the email content and the attachment of the reply email, wherein the report at least includes the material number, the delivery date, and response information of the supplier device. In addition, the report may be directly applied to the internal approval process of the purchasing system to save a lot of time and labor costs. It should be noted that the fields of the report 400 are not intended to limit the present disclosure, and those skilled in the art can make appropriate replacements or adjustments according to this embodiment.

In yet another embodiment, the report 400 is presented by a user interface. The user of the purchasing party may clearly view the email content in the reply email sent by the supplier device, the information analyzed by the large language model, and the report results finally generated by the large language model or the program through the user interface. The device also allows the users to make final confirmation and necessary modifications to ensure that the content of the report is consistent with the actual situation, greatly improving the user's work efficiency and reducing the risk of information errors.

As described above, the method and device for automatically analyzing emails proposed in the present disclosure automatically analyzes the reply emails from the supplier device using a large language model, compares and confirms each component number or material number one by one, and generates a corresponding report. The device may automatically fill in the report with the reply results according to the content of the reply email sent by the supplier device. Users or purchasing personnel only need to confirm whether these automatically generated results are correct through the device. Once confirmed, the device may continue to execute subsequent processes without the user having to manually sort out a large number of reply emails. In this automated process, all reply emails sent by the supplier device may be automatically stored in the device for users or purchasing personnel to check at any time. The device may automatically check whether the supplier device fails to reply to the reply email within a predetermined time. When the supplier device fails to reply to the reply email within the predetermined time, the device immediately reminds the purchasing personnel to carry out follow-up processing. Such an automated process can not only improve procurement efficiency, but also reduce the occurrence of human errors, thereby improving the accuracy and speed of the overall procurement process.

The embodiments described herein, including systems, methods/processes, and/or apparatuses, may be implemented using well known computers, such as the electronic device 500 shown in FIG. 5. The electronic device 500 is described as follows, for purposes of illustration.

Referring to FIG. 5, an exemplary operating environment for implementing embodiments of the present disclosure is shown and generally known as an electronic device 500. The electronic device 500 is merely an example of a suitable computing environment and is not intended to limit the scope of use or functionality of the disclosure. Neither should the electronic device 500 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 5, the electronic device 500 may include a bus 510 that is directly or indirectly coupled to the following devices: one or more memories 512, one or more processors 514, one or more display components 516, one or more input/output (I/O) ports 518, one or more input/output components 520, and an illustrative power supply 522. The bus 510 may represent one or more kinds of buses (such as an address bus, data bus, or any combination thereof). Although the various blocks of FIG. 5 are shown with lines for the sake of clarity, and in reality, the boundaries of the various components are not specific. For example, the display component such as a display device may be considered an I/O component and the processor may include a memory.

The electronic device 500 typically includes a variety of computer-readable media. The computer-readable media can be any available media that can be accessed by electronic device 500 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 500. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 512 may include computer-storage media in the form of volatile and/or nonvolatile memory. The memory may be removable, non-removable, or a combination thereof. Exemplary hardware devices include solid-state memory, hard drives, optical-disc drives, etc. The electronic device 500 includes one or more processors that read data from various entities such as the memory 512 or the I/O components 520. The display component(s) 516 present data indications to a user or to another device. Exemplary presentation components include a display device, speaker, printing component, vibrating component, etc.

The I/O ports 518 allow the electronic device 500 to be logically coupled to other devices including the I/O components 520, some of which may be embedded. Illustrative components include a microphone, joystick, game pad, satellite dish, scanner, printer, wireless device, etc. The I/O components 520 may provide a natural user interface (NUI) that processes gestures, voice, or other physiological inputs generated by a user. For example, inputs may be transmitted to an appropriate network element for further processing. The electronic device 500 may be equipped with depth cameras, such as stereoscopic camera systems, infrared camera systems, RGB camera systems, or any combination thereof, to detect and identify objects. In addition, the electronic device 500 may be equipped with sensors (e.g., radar, lidar) to periodically sense the surrounding environment within a sensing range and generate sensor information representing the relationship between the electronic device 500 and the surrounding environment. Furthermore, the electronic device 500 may be equipped with accelerometers or gyroscopes that enable detection of motion. The output of the accelerometers or gyroscopes may be provided to the electronic device 500 for display.

Furthermore, the processor 514 in the electronic device 500 can execute the program code in the memory 512 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded with the broadest interpretation so as to encompass all such modifications and similar arrangements.

What is claimed is:

1. A method for automatically analyzing emails, wherein the method is implemented by a processor of a device, and comprises:
receiving a reply email sent by a supplier device, wherein the reply email is used to reply to demands for purchasing goods; and
generating a report corresponding to the demands for purchasing goods using one or more large language models (LLMs) according to a subject, an email content, and replier information of the reply email.

2. The method for automatically analyzing emails as claimed in claim 1, further comprising:
classifying the reply email according to the email content;
wherein types used to classify the reply email at least include an order inquiry, a delivery inquiry, and an order cancellation inquiry.

3. The method for automatically analyzing emails as claimed in claim 1, wherein before receiving the reply email sent by the supplier device, the method further comprises:
sending an inquiry email to the supplier device, wherein the inquiry email includes the demands for purchasing goods.

4. The method for automatically analyzing emails as claimed in claim 3, further comprising:
comparing the inquiry email with the reply email to confirm whether the demands for purchasing goods have been responded to in the reply email; and
generating the report when the demands for purchasing goods have been responded to in the reply email.

5. The method for automatically analyzing emails as claimed in claim 4, further comprising:
sending a notification message to notify a user using the device when the demands for purchasing goods are not responded to in the reply email.

6. The method for automatically analyzing emails as claimed in claim 1, wherein the report at least includes a material number, a delivery date, and response information of the supplier device.

7. The method for automatically analyzing emails as claimed in claim 1, wherein the reply email further includes an attachment regarding the demands for purchasing goods.

8. The method for automatically analyzing emails as claimed in claim 7, wherein the step of generating the report using the one or more LLMs further comprises:
reading the subject, the email content, the replier information and title information in the attachment using the one or more LLMs to generate the report.

9. The method for accessing shared files as claimed in claim 7, wherein the step of generating the report using the one or more LLMs further comprises:
executing a program to read the subject, the email content, the replier information and title information in the attachment;
executing the program to put a prompt into a template of the reply email, and providing the subject, the email content, the replier information and the attachment to the one or more LLMs, so that the one or more LLMs generate a reply result; and
executing the program to generate the report based on the reply result and the reply email.

10. The method for accessing shared files as claimed in claim 1, further comprising:
sending an overdue notification message to a user using the device to notify the user that the device has not received the reply email sent by the supplier device when the reply email sent by the supplier device is not received within a predetermined time.

11. A device for automatically analyzing emails, comprising:
one or more processors; and
one or more computer storage media for storing one or more computer-readable instructions, wherein the processor is configured to drive the computer storage media to execute the following tasks:
receiving a reply email sent by a supplier device, wherein the reply email is used to reply to demands for purchasing goods; and
generating a report corresponding to the demands for purchasing goods using one or more large language models (LLMs) according to a subject, an email content, and replier information of the reply email.

12. The device for automatically analyzing emails as claimed in claim 11, wherein the processor further executes the following tasks:
classifying the reply email according to the email content;
wherein types used to classify the reply email at least include an order inquiry, a delivery inquiry, and an order cancellation inquiry.

13. The device for automatically analyzing emails as claimed in claim 1, wherein before receiving the reply email sent by the supplier device, the processor further executes the following tasks:
sending an inquiry email to the supplier device, wherein the inquiry email includes the demands for purchasing goods.

14. The device for automatically analyzing emails as claimed in claim 13, wherein the processor further executes the following tasks:
comparing the inquiry email with the reply email to confirm whether the demands for purchasing goods have been responded to in the reply email; and
generating the report when the demands for purchasing goods have been responded to in the reply email.

15. The device for automatically analyzing emails as claimed in claim 14, wherein the processor further executes the following tasks:
sending a notification message to notify a user using the device when the demands for purchasing goods are not responded to in the reply email.

16. The device for automatically analyzing emails as claimed in claim 11, wherein the report at least includes the material number, the delivery date, and response information of the supplier device.

17. The device for automatically analyzing emails as claimed in claim 11, wherein the reply email further includes an attachment regarding the demands for purchasing goods.

18. The device for automatically analyzing emails as claimed in claim 17, wherein the step of generating the report using the one or more LLMs further comprises:
reading the subject, the email content, the replier information and title information in the attachment using the one or more LLMs to generate the report.

19. The device for accessing shared files as claimed in claim 17, wherein the step of generating the report using the one or more LLMs further comprises:
executing a program to read the subject, the email content, the replier information and title information in the attachment;
executing the program to put a prompt into a template of the reply email, and providing the subject, the email content, the replier information and the attachment to the one or more LLMs, so that the one or more LLMs generate a reply result; and
executing the program to generate the report using the program based on the reply result and the reply email.

20. The device for accessing shared files as claimed in claim 11, wherein the processor further executes the following tasks:
sending an overdue notification message to a user using the device to inform the user that the device has not received the reply email sent by the supplier device when the reply email sent by the supplier device is not received within a predetermined time.
